(19) United States
(12) Patent Application Publication
(10) Pub. No.: US 2019/0102105 A1
(43) Pub. Date: Apr. 4, 2019

(54) VARIABLE CONFIGURATION MEDIA CONTROLLER

(71) Applicant: Burlywood, LLC, Longmont, CO (US)

(72) Inventors: Christopher Bergman, Erie, CO (US); David Christopher Pruett, Longmont, CO (US)

(21) Appl. No.: 16/144,349

(22) Filed: Sep. 27, 2018

Related U.S. Application Data
(60) Provisional application No. 62/565,647, filed on Sep. 29, 2017.

(51) Int. Cl. G06F 3/06; G06F 17/30

(52) U.S. Cl. CPC G06F 3/0658; G06F 3/0619; G06F 17/30946; G06F 3/0661; G06F 3/0673

(57) ABSTRACT

A storage controller is provided. The storage controller includes a host interface, a media interface, and a processing system. The processing system is configured to receive data from the host system, select write locations within the storage media for writing the data, and to select a write format based at least in part on the write locations within the storage media. The processing system is further configured to select write parameters based at least in part on the write locations within the storage media and media states of the write locations within the storage media, and to write the data to the write locations within the storage media using the selected write format and write parameters.

### RELATED APPLICATIONS

This application hereby claims the benefit of and priority to U.S. Provisional Patent Application No. 62/565,647, titled “RUN-TIME VARIABLE CONFIGURATION FLASH CHANNEL”, filed on Sep. 29, 2017 and which is hereby incorporated by reference in its entirety.

### TECHNICAL FIELD

Aspects of the disclosure are related to data storage and in particular to applying different parameters and formats to different partitions within a memory.

### TECHNICAL BACKGROUND

Typical flash memory devices comprise a very large number of individual cells. Each cell is capable of storing data in the form of a voltage. Upon reading a cell, the stored voltage is compared to one or more threshold voltages to determine the data stored in the cell. Due to a number of factors, the voltage read from the cell may not be the ideal voltage stored in the cell with respect to the threshold voltages. This may result in an error in reading the data from the cell.

Flash memory devices typically use error detection and correction codes in order to detect and recover from data errors. Even using error detection and correction codes, data integrity is dependent upon accurate placement of the target voltage stored in the cell with respect to the threshold voltages, and the stability of that target voltage over time and environmental conditions. Error bit rates vary for a variety of reasons, but are often dominated by the placement of voltage levels at the time of programming, their drift after programming, and the available margin between threshold voltage levels.

### OVERVIEW

In an embodiment, a storage controller for a storage system is provided. The storage controller includes a host interface, a media interface, and a processing system. The processing system is configured to receive data from the host system, select write locations within the storage media for writing the data, and to select a write format based at least in part on the write locations within the storage media.

The processing system is further configured to select write parameters based at least in part on the write locations within the storage media and media states of the write locations within the storage media, and to write the data to the write locations within the storage media using the selected write format and write parameters.

In another embodiment, a method of operating a storage controller, is provided. The method includes receiving data from a host system, selecting write locations within storage media in the storage system for writing the data, and selecting a write format based at least in part on the write locations within the storage media.

The method also includes selecting write parameters based at least in part on the write locations within the storage media and media states of the write locations within the storage media, and writing the data to the write locations within the storage media using the selected write format and write parameters.

In a further embodiment, a storage device is provided. The storage device includes a data storage medium comprising data storage locations, and a controller, coupled to the data storage medium and configured to store data onto the data storage medium.

The controller is configured to receive data from a host system, select write locations within the data storage media for writing the data, and to select a write format based at least in part on the write locations within the data storage media.

The controller is also configured to select write parameters based at least in part on the write locations within the data storage media and media states of the write locations within the data storage media, and to write the data to the write locations within the data storage media using the selected write format and write parameters.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computer host and data storage system.

FIG. 2 illustrates a variable configuration media controller and storage media within a data storage system.

FIG. 3 illustrates a method for operating a variable configuration media controller for flash memory within a storage system.

FIG. 4 illustrates a method for operating a variable configuration media controller for flash memory within a storage system.

FIG. 5 illustrates an example flash memory configuration.

FIG. 6 illustrates an example graph of stored voltages and voltage thresholds within a flash memory.

FIG. 7 illustrates an example graph of stored voltages and voltage thresholds within a flash memory showing an increased raw bit error rate.

FIG. 8 illustrates an example graph of stored voltages and voltage thresholds within a flash memory showing an increased raw bit error rate.

FIG. 9 illustrates an example format database and example read and write parameters databases.

FIG. 10 illustrates an example format hierarchy.

FIG. 11 illustrates an example flow chart for determining write parameters and a write format.

FIG. 12 illustrates an example flow chart for determining read parameters and a read format.

FIG. 13 illustrates an example graph of stored voltages and voltage thresholds within a flash memory having a bi-modal distribution.

FIG. 14 illustrates an example graph of stored voltages and voltage thresholds within a flash memory for reading one part of the data illustrated in FIG. 13.

FIG. 15 illustrates an example graph of stored voltages and voltage thresholds within a flash memory for reading a different part of the data illustrated in FIG. 13.

FIG. 16 illustrates an example variable configuration media controller.

### DETAILED DESCRIPTION

The following terms are used throughout the following detailed description of the invention, and are defined below.

Single Level Cell (SLC)—A NAND flash density where a cell distinguishes between two voltage levels to store one bit of data.

Multi Level Cell (MLC)—A NAND flash density where a cell distinguishes between four voltage levels to store two bits of data.

Triple Level Cell (TLC)—A NAND flash density where a cell distinguishes between eight voltage levels to store three bits of data.

Quad Level Cell (QLC)—A NAND flash density where a cell distinguishes between sixteen voltage levels to store four bits of data.

LUN—Logical unit (also commonly referenced as die). A collection of NAND cells typically organized into planes, blocks, wordlines/pages that can be independently execute commands and report status. Consists of multiple planes

Plane—A partitioning of the LUN that allows similar concurrent operations. Consists of multiple blocks.

Block—The smallest addressable unit for erase operations. Consists of multiple wordlines.

Wordline—The collection of cells (programmed and read as a group) that make up one or more pages depending on density.

Page—The smallest addressable unit for read and write operations. Some write operations in advanced 3D memories require multiple pages to be programmed at the same time.

Column—Location (offset) within a page

Read Thresholds—The set of read levels used to detect the state of a given cell which encodes the digital value or values written to the cell in a specific density.

Endurance—A measure of the number of program/erase cycles that NAND flash media can endure before the RBER becomes too large to be usable in a given system.

Read Disturb—Reading certain types of media (including NAND flash) can increase the RBER of that media. This phenomenon is referred to as read disturb.

Program Disturb—Programming certain types of media (including NAND flash) can increase the RBER on other areas of the media (either already programmed or erased). The phenomena is referred to as program disturb.

Retention—The ability of a media (including NAND flash) to retain its programmed information over time.

Raw Bit Error Rate (RBER)—A metric for data corruption rate equal to the number of data errors per bit read before applying any specified error-correction method. This is the native error rate of the underlying media and is useful in predicting performance and failure rates of error-correction methods.

Uncorrectable Bit Error Rate (UBER)—A metric for data corruption rate equal to the number of data errors per bit read after applying any specified error-correction method.

Error Correction Code—A method of adding redundancy to the source data in such a way as to allow for error detection and correction.

Code Rate—The ratio of source data to (source data+added redundancy) for an error correction code. This ratio is a measure of the efficiency of a specific error correction code.

Low Density Parity Check Code (LDPC)—A relatively new error correction code that is highly efficient, but can suffer from complex and costly (size and power) hardware implementations.

Soft Data—A method of reading the target media to provide more information as to the reliability of the information being gathered. Certain error correction codes can use this information to better converge on a solution and increase their correction power at a given code rate.

Bose-Chaudhuri-Hocquenghem (BCH) Code—A commonly used cyclic error correction code.

Migration—Moving data from one physical location in a system to another. Common reasons for doing this are to preserve data integrity or to defragment the media.

Read Retry—A term used generically to refer to any sort of attempt to recover data that was not successfully recovered on the first read attempt by re-reading the data in some manner This could be a simple re-read, a re-read with some alternate settings in the device, a re-read employing some sort of alternate ECC strategy, etc.

RAID/RAIN—Redundant Array of Independent Disks/Nodes.

3D NAND—A manufacturing process for NAND flash media where the geometry is extended to 3 dimensions by layering techniques.

Multi-pass programming—A media programming technique where the desired information is programmed to the target location in more than one step. This is typically done to reduce the overall RBER of the location being programmed and its neighbors.

In various embodiments, NAND flash memory cells may be configured to store one or more bits of data. In a very common embodiment, one of two different voltages is stored in a NAND cell representing one bit of data. This is called a Single Level Cell (SLC), and uses a single threshold voltage to distinguish between the two possible stored voltages.

In other embodiments, one of eight different voltages is stored in a NAND cell representing three bits of data. This is called a Triple Level Cell (TLC) and uses seven threshold voltages to distinguish between the eight possible stored voltages. Several current manufacturers are producing Quad Level Cell (QLC) NAND flash memories where one of 16 different voltages is stored in a NAND cell representing four bits of data.

As more and more data is stored in a single NAND cell, the margins for error in storing and reading voltages from the NAND cell decrease dramatically. Even slight drifts of storage voltages may result in increased raw bit error rates (RBER) across the memory.

As described in further detail below, any of a number of factors may influence the ability of a NAND cell to accurately record a target voltage. Also, these factors may vary across a single NAND die or wafer. For example, one side of the die may have a slight manufacturing defect such that is records consistently lower voltages than the other side of the same die. This may result in a higher RBER as the margin between the stored voltages and the threshold voltages shrinks or even disappears.

One example embodiment of the present invention provides a variable configuration media controller that is capable of writing data to a storage media (such as NAND flash memory) using different write formats and write parameters for different partitions within the storage media.

These write formats may include different ECC methods used in different partitions. For example, for partitions showing a higher RBER, a more robust ECC may be used. This is simply one example, as other write formats may be used within the scope of the present invention.

Write parameters may include different threshold voltages for different partitions. For example, from the example above, the side of the NAND die recording consistently lower voltages, may be configured with write parameters lowering the threshold voltages for partitions on that side of the die, thus decreasing the RBER. This is simply one example, as other write parameters may be used within the scope of the present invention.

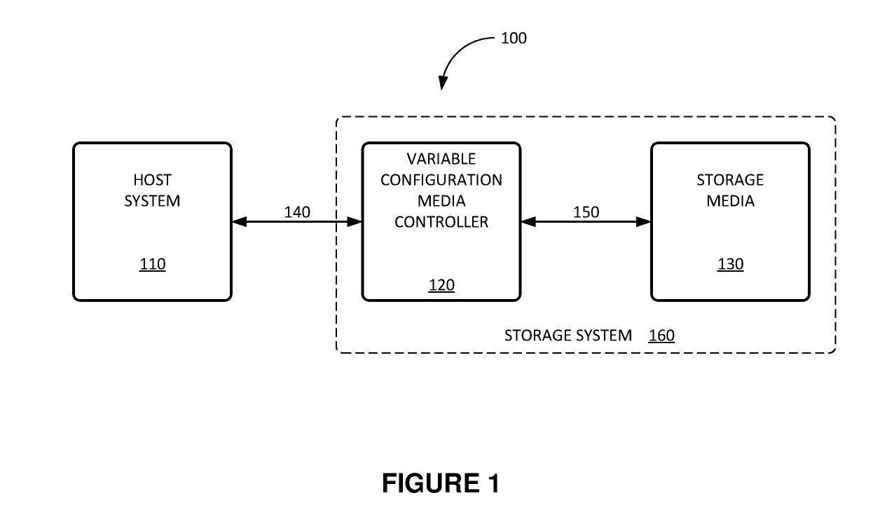

FIG. 1 illustrates computer host and data storage system 100. In this example embodiment, host system 110, sends data to, and receives data from, variable configuration media controller 120 for storage in storage media 130. Variable configuration media controller 120 communicates with host system 110 over link 140, and with storage media 130 over link 150. Together variable configuration media controller 120 and storage media 130 make up storage system 160.

Variable configuration media controller 120 is configured to receive data from host system 110 over link 140, and select locations within storage media 130 to store the host data. Based on the selected locations, and on media states of the selected locations, variable configuration media controller 120 selects a write format and write parameters for writing the host data to the selected locations within storage media 130.

Media states of the locations within storage media 130 may include factors such as cell density, encoding scheme (SLC, MLC, TLC, or QLC), status of the storage cells physical neighbors, cell wear, time since last read, temperature, and many other factors. These media states are used by variable configuration media controller 120 in selecting the best data format and parameters to reduce the RBER of the stored data as much as possible.

When reading data from storage media 130, variable configuration media controller 120 considers the write format and write parameters used to write the stored data along with the media states of the location where the data is stored. It then selects read parameters and a read format to use when reading the stored data in order to minimize the RBER of the read data.

Variable configuration media controller 120 may take any of a variety of configurations. In some examples, variable configuration media controller 120 may be a Field Programmable Gate Array (FPGA) with software, software with a memory buffer, an Application Specific Integrated Circuit (ASIC) designed to be included in a single module with storage media 130 (such as storage system 160), a set of Hardware Description Language (HDL) commands, such as Verilog or System Verilog, used to create an ASIC, a separate module from storage media 130, or any of many other possible configurations.

Host system 110 communicates with variable configuration media controller 120 over communication link 140. This communication link may use the Internet or other global communication networks. The communication link may comprise one or more wireless links that can each further include Long Term Evolution (LTE), Global System for Mobile Communications (GSM), Code Division Multiple Access (CDMA), IEEE 802.11 WiFi, Bluetooth, Personal Area Networks (PANs), Wide Area Networks, (WANs), Local Area Networks (LANs), or Wireless Local Area Networks (WLANs), including combinations, variations, and improvements thereof. This communication link can carry any communication protocol suitable for wireless communications, such as Internet Protocol (IP) or Ethernet.

Additionally, communication links can include one or more wired portions which can comprise synchronous optical networking (SONET), hybrid fiber-coax (HFC), Time Division Multiplex (TDM), asynchronous transfer mode (ATM), circuit-switched, communication signaling, or some other communication signaling, including combinations, variations or improvements thereof. Communication links can each use metal, glass, optical, air, space, or some other material as the transport media. Communication links may each be a direct link, or may include intermediate networks, systems, or devices, and may include a logical network link transported over multiple physical links. Common storage links include SAS, SATA, NVMe, Ethernet, Fiber Channel, Infiniband, and the like.

Storage controller 120 communicates with storage media 130 over link 150. Link 150 may be any interface to a storage device or array. In one example, storage media 130 comprises NAND flash memory and link 150 may use the Open NAND Flash Interface (ONFI) command protocol, or the “Toggle” command protocol to communicate between storage controller 120 and storage media 130. Other embodiments may use other types of memory and other command protocols. Other common low level storage interfaces include DRAM memory bus, SRAM memory bus, and SPI.

Link 150 can also be a higher level storage interface such as SAS, SATA, PCIe, Ethernet, Fiber Channel, Infiniband, and the like. However—in these cases, storage controller 120 would reside in storage system 160 as it has its own controller.

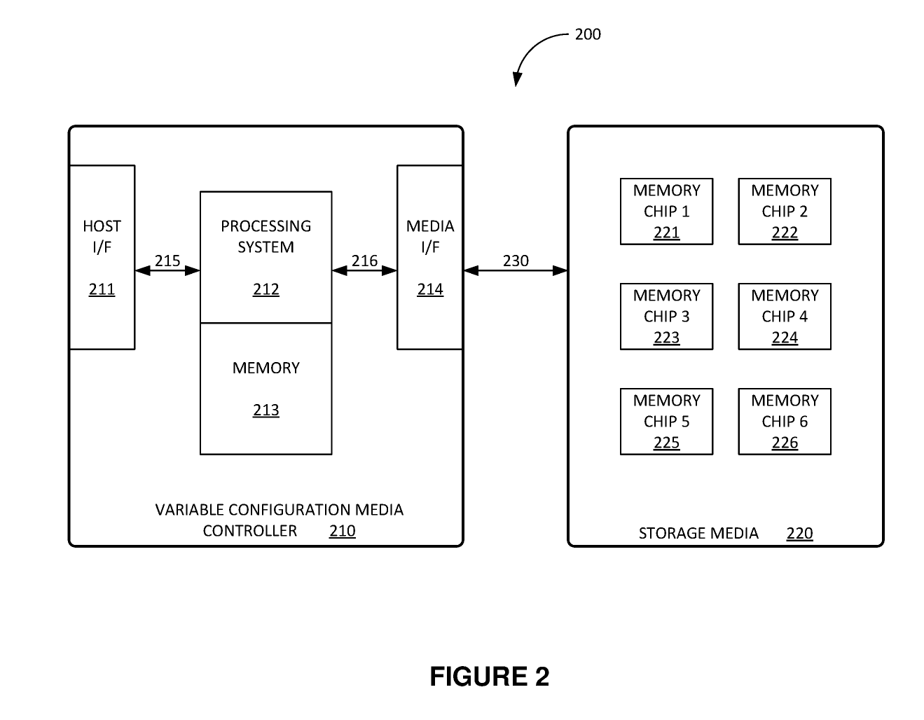

FIG. 2 illustrates a variable configuration media controller 210 and storage media 220 within a data storage system 200. In this example embodiment of the present invention, variable configuration media controller 120 from FIG. 1 is illustrated in more detail.

Here variable configuration media controller 210 includes host interface 211, processing system 212, memory 213 and media interface 214. Host interface 211 communicates with processing system 212 over communication link or bus 215, while media interface 214 communicates with processing system 212 over communication link or bus 216. Variable configuration media controller 210 communicates with storage media 220 over communication link 230, which may be similar to communication link 150 from FIG. 1.

In this example embodiment, memory 213 may contain data and software used by processing system 212 to operate variable configuration media controller 210 as described herein. Host interface 211 is configured to receive data from, and transmit data to, host system 110. Media interface 214 is configured to transmit data to, and receive data from, storage media 120.

In this example, storage media 220 includes six memory chips or dies: memory chips 1-6 221-226, however other embodiments may use any number of memory chips within the scope of the present invention.

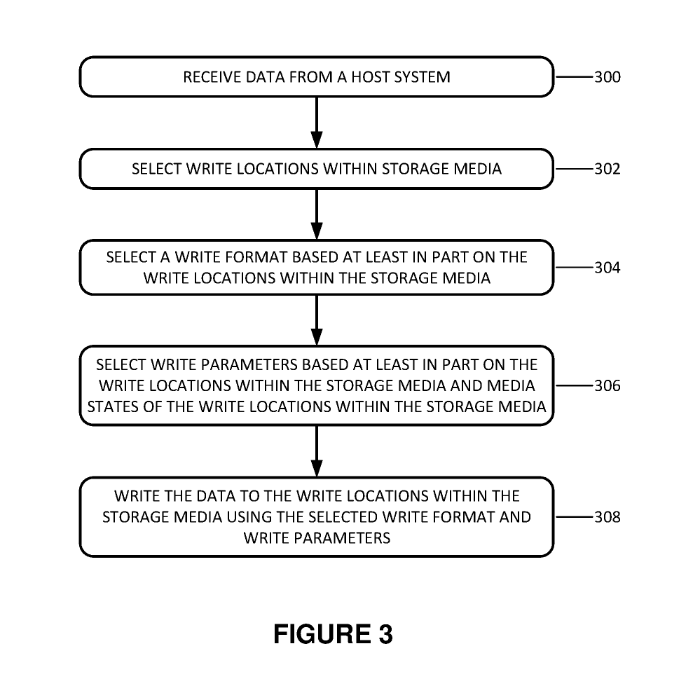

FIG. 3 illustrates a method for operating a variable configuration media controller 120 for flash memory 130 to store data within a storage system 160. In this example embodiment, variable configuration media controller 120 receives data from host system 110, (operation 300). Variable configuration media controller 120 then selects locations within storage media 130 for writing the data, (operation 302).

Variable configuration media controller 120 selects a write format based at least in part on the selected write locations within storage media 130, (operation 304). Variable configuration media controller 120 also selects write parameters for the data based at least in part on the write locations within storage media 130, and media states of the write locations within storage media 130, (operation 306).

Variable configuration media controller 120 then writes the data to the write locations within storage media 130 using the selected write format and write parameters, (operation 308).

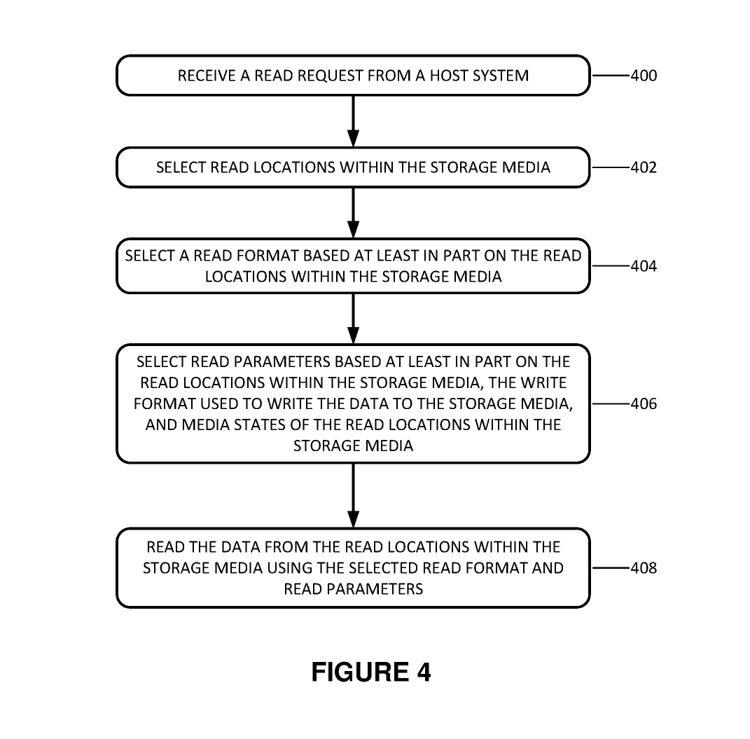

FIG. 4 illustrates a method for operating a variable configuration media controller 120 for flash memory 130 to read data within a storage system 160. In this example, variable configuration media controller 120 receives a read request from host system 110, (operation 400). Variable configuration media controller 120 selects read locations within storage media 130 based on the read request, (operation 402).

Variable configuration media controller 120 selects a read format based at least in part on the read locations within storage media 130, (operation 404). Variable configuration media controller 120 selects read parameters based at least in part on the read locations within storage media 130, the write format used to write the data to storage media 130, and media states of the read locations within storage media 130, (operation 406).

Variable configuration media controller 120 then reads the data from the read locations within storage media 130 using the selected read format and read parameters, (operation 408).

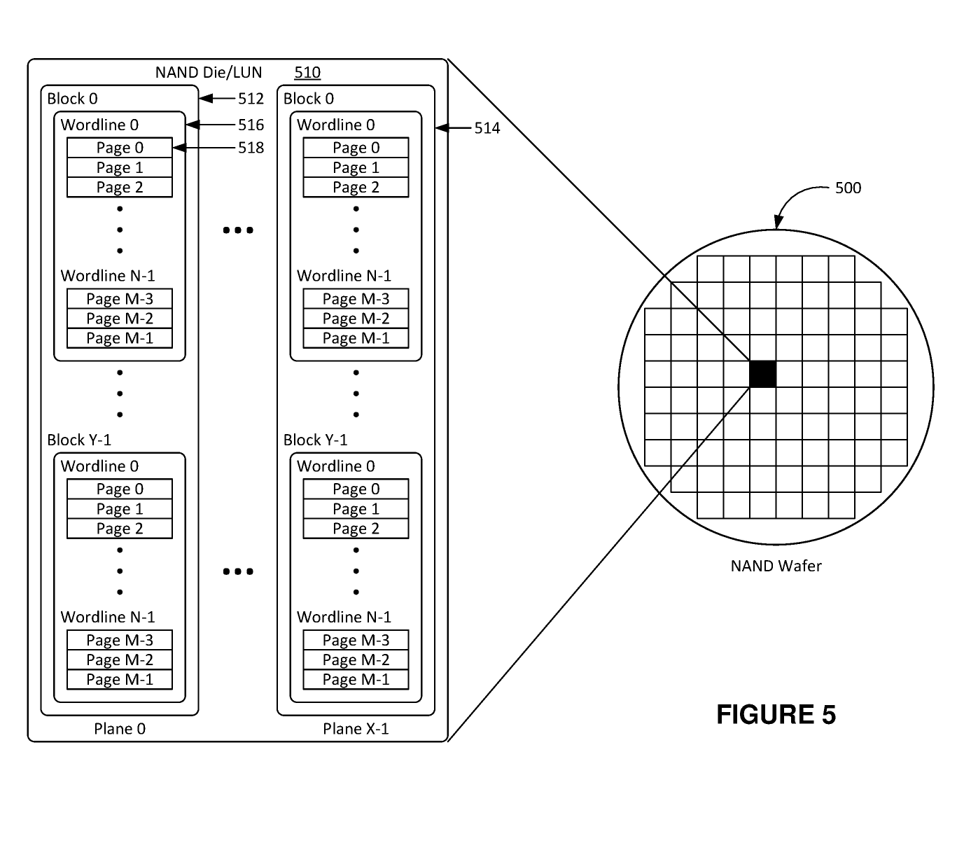

NAND flash devices consist of a large number of cells. A voltage, stored in the cell, may be used to store data. A single threshold, distinguishing two voltage levels may be used to store one bit (SLC). Increasing the number of voltages allows for more bits to be stored per cell (MLC, TLC, QLC, etc.). Cells, in turn, are arranged into word lines, groups of word lines into blocks, groups of blocks into planes; and, finally, groups of planes into a logical unit (LUN). Wordlines can be partitioned into multiple pages in the case densities beyond one bit per cell (SLC). Flash devices vary in the precise number and arrangement of planes, blocks, wordlines, pages, and cells. FIG. 5 highlights a hypothetical NAND LUN with X planes, Y blocks per plane, N wordlines per block, and three pages per wordline.

FIG. 5 illustrates an exemplary flash geometry. In this example embodiment, NAND Die/LUN 510 is one of the plurality of dies from NAND wafer 500. NAND Die/LUN 510 includes Plane 0 512 through Plane X-1 514. Each plane, such as Plane 0 512 includes Blocks 0 through Y-1. Each block, such as Block 0 516 includes Wordlines 0 through N-1. Each wordline, such as Wordline 0 518 includes three pages. This is simply on example flash geometry. Many other flash geometries are possible within the scope of the present invention.

NAND flash devices are noisy in that they require error detection and correction codes to ensure data integrity at even the most reliable densities (SLC) and technology nodes. Data integrity and reliable data recovery is dependent upon accurate placement of target voltages on each cell and the stability of those voltages over time and condition. The error rate exhibited varies for a variety of reasons, but is dominated by the placement of the voltage levels at the time of programming, their drift after programming, and the available margin between voltage levels.

Examples of factors that influence the cell's ability to place the encoded voltage levels for a desired density are:
Overall NAND flash manufacturing process variation
Location of cells within a wafer (die location)
Location of the cells within a die, plane, block, wordline, or layer (for a 3D technology)
Endurance or number of program/erase cycles already experienced by the cell
Temperature at the time of programming

Examples of factors that influence a cell's ability to maintain its target voltage and margin between voltages are:
Density (number of possible target voltages for each cell limits available margin)
Choice of encoding scheme for densities beyond SLC (# thresholds required for reading each “bit” of a cell)
Whether a cell's neighbors are fully programmed or not
The data pattern applied to a cell and its neighbors
The state of the cell relative to its final state (see multi-pass programming algos)
Temperature at write vs. temperature at read
Retention—Elapsed time from program to read
Read disturb
Time since last read

Together, these factors comprise possible media states that may be used by variable configuration media controller 120 in determining read and write parameters for the cells in order to reduce the RBER of the cells.

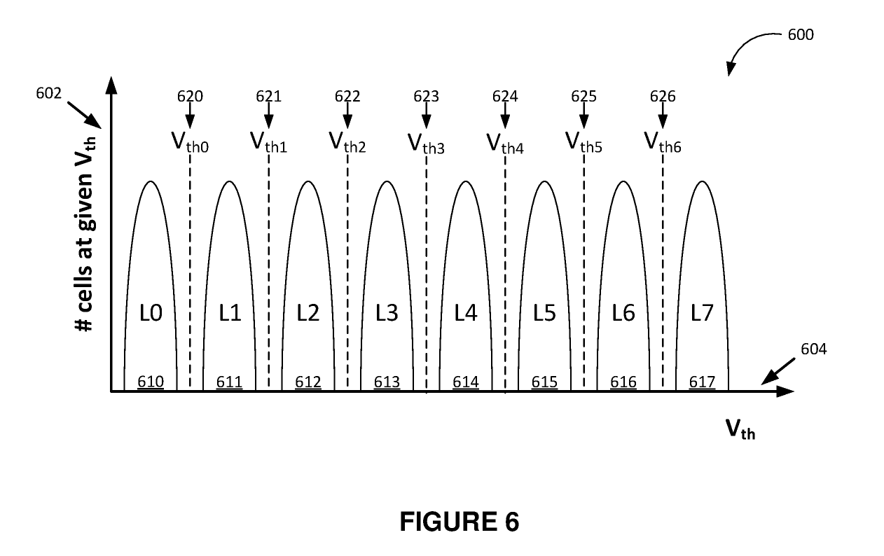

FIG. 6 illustrates an example graph 600 of stored voltages and voltage thresholds within a flash memory. The example illustrated by FIG. 6 is an ideal TLC scenario. In this case all of the cells were programmed at or near their target voltages with a small distribution such that there is a large amount of margin between each level's distribution.

In this example graph a distribution of the number of cells at a given voltage 602 are plotted against threshold voltages 604. This example cell is configured to store one of eight different voltages, thus storing three bits of data. Each storage voltage 610-617 has a distribution labeled here as L0-L7. Note that each storage voltage distribution is wholly contained between the seven threshold voltages Vth0-6 620-626. In this ideal case, sampling the cells using the read thresholds Vth0-6 would result in the lowest possible RBER.

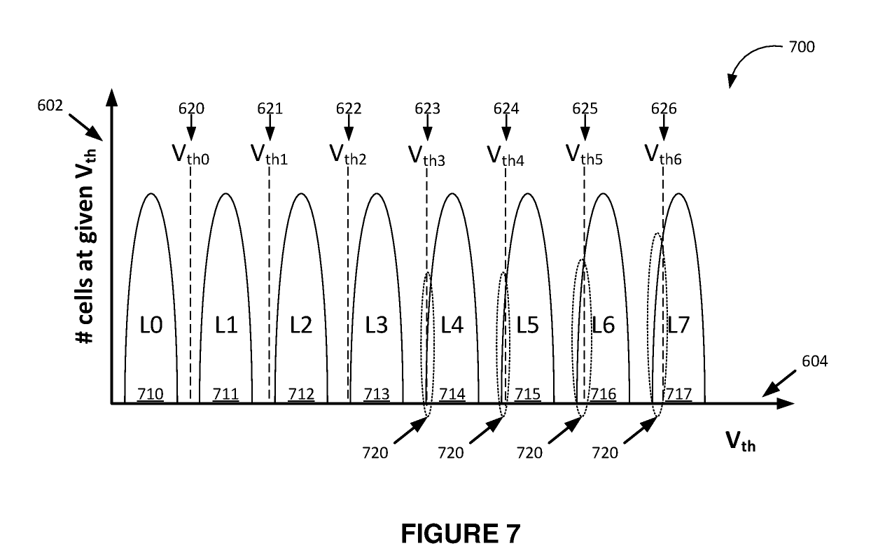

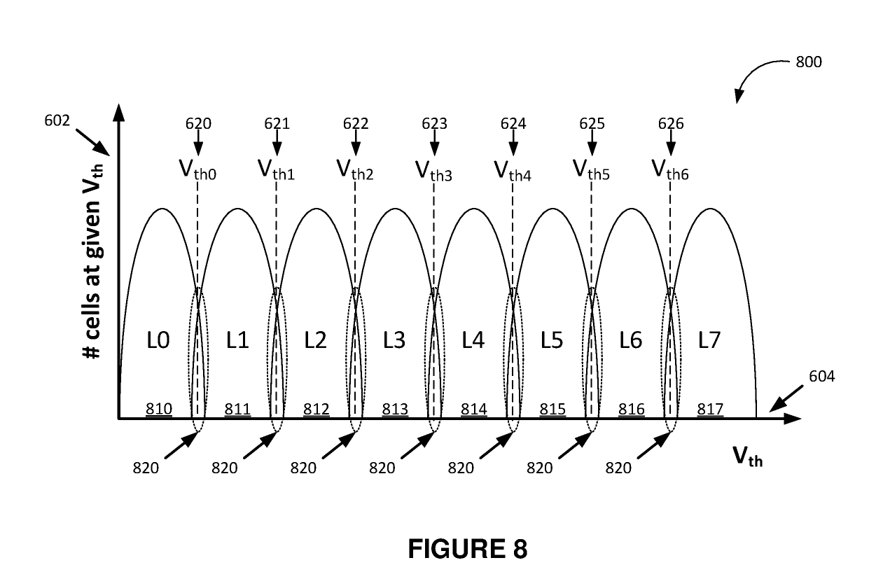

Situations like FIG. 6 are not common in the real world. Situations like FIG. 7 or FIG. 8 (or worse) are more common. They show cases where the voltages were not placed properly at programming time or they moved over time or their distributions widened over time. In either case the RBER of these sets of cells would be higher than the RBER from FIG. 6 due to the areas highlighted. This would require the use of a more powerful ECC, alternate read thresholds, or both.

FIG. 7 illustrates an example graph 700 of stored voltages and voltage thresholds within a flash memory showing an increased raw bit error rate due to improper Vt placement. This example is similar to that of FIG. 6 except that the stored voltages have shifted to lower voltages.

Each storage voltage 710-717 has a distribution labeled here as L0-L7. Note that each storage voltage distribution is no longer wholly contained between the seven threshold voltages Vth0-6 620-626. In fact, distributions L4-L7 now cross threshold voltages Vth3 through Vth6, respectively. This overlap is highlighted as elements 720.

FIG. 8 illustrates an example graph 800 of stored voltages and voltage thresholds within a flash memory showing an increased raw bit error rate due to wide Vt distributions. This example is similar to that of FIG. 6 except that each distribution of the stored voltages has expanded. In fact, each stored voltage distribution now overlaps its adjacent threshold voltages.

Here each storage voltage 810-817 has a distribution labeled here as L0-L7. Note that each storage voltage distribution is no longer wholly contained between the seven threshold voltages Vth0-6 620-626. These overlaps 820 result in an increased RBER for the cells within this example.

The RBER of a given system can be approximated as a function of the initial placement of cell voltages, distribution of voltages across cells, drift of cell voltages, and read thresholds used during read. Typically, an error correction code and corresponding code rate are chosen to obtain a target UBER given this RBER function. The RBER function is typically not constant and can be dominated by outliers. This causes many problems for a system that uses a single error correction code, code rate, and set of write and read parameters.

Examples of the issues this causes for a system are:
Loss of capacity due to selecting a code rate based on the outliers with higher RBER. (increased cost)
Increased write amplification due to data integrity triggered migrations if the code rate is selected based on the general population and not the outliers. (increased cost and/or reduced life)
Early retirement if the code rate is selected based on the general population and not the outliers. (increased cost and/or reduced life)
Read latency issues and increased power consumption due to increased read retry triggers.
Lower yield if screening NAND based on the outliers. (Important when screening NAND at the wafer level.)
Choosing an error correction code that is over-designed based on outliers of the RBER function can increase the complexity, size, cost, and power of a solution implemented in an ASIC or FPGA. An example would be the complexity, size, cost, and power of a BCH code vs. an LDPC code.
Increased cost if selecting a higher grade of media than is actually required to compensate for any/all of the issues above.

By efficiently supporting frequent changes to the error detection and correction codes during read and write operations and read and write parameters, the present invention avoids many or all of the issues above and supports a wide variety of flash devices while optimizing the capacity, performance, cost, and power of a given system.

As described above, all of the sources of error-rate variance could be addressed with a fixed ECC code and code rate by calibrating the error correction codes for the worst-case error rate assuming the nominal read and write parameters. The approach described here, though, allows for the use of multiple error correction codes, code rates, write parameters, and read parameters, optimized for a variety of densities, physical regions, wear-levels, and other conditions in a way that has little to no impact to system latency and performance.

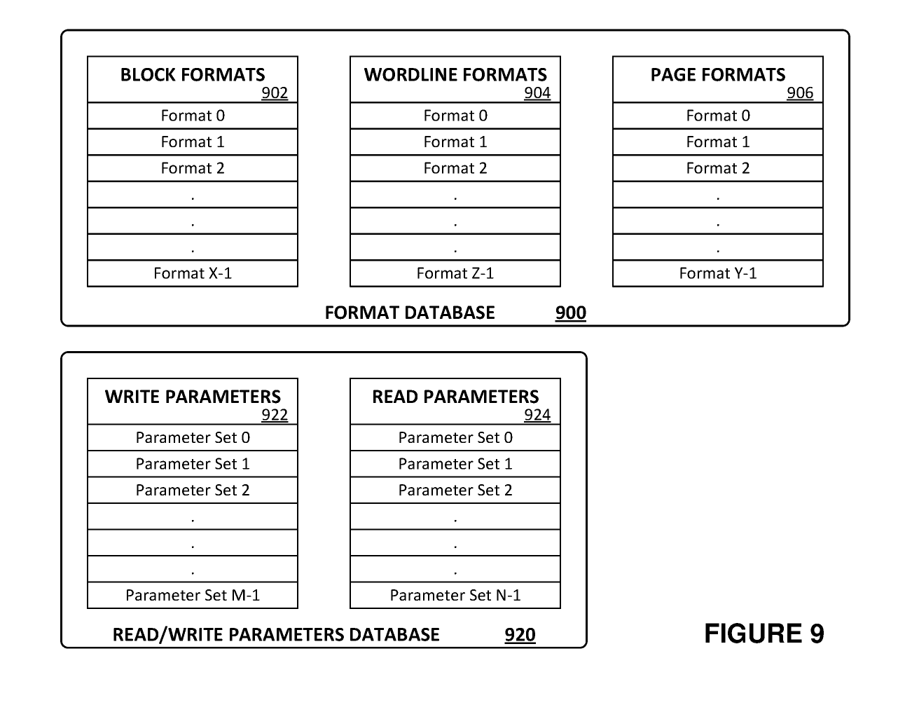

FIG. 9 illustrates an example format database 900 and example read and write parameters databases 920. The format database 900 is a hierarchical set of formats (FMTs) describing the ECC configurations created to support the varying RBER conditions of the system. In this example, format database 900 includes X block formats 902, Z wordline formats 904, and Y page formats 906.

The read 922 and write 924 parameter databases 920 describe a set of parameters that can be altered with each read and write operation. The values for each entry are created to compensate for the varying conditions experienced by the system. The types of parameters present in the database can vary greatly based on the type of media being used and the media's available capabilities. Examples are the following (note that the present invention is not limited to using only these parameters):
Internal NAND device feature settings.
Internal NAND device register settings.
Use of special write or read modes. (e.g. soft data read, internal device calibration reads, etc.)
Use and/or modification of external supply voltages.

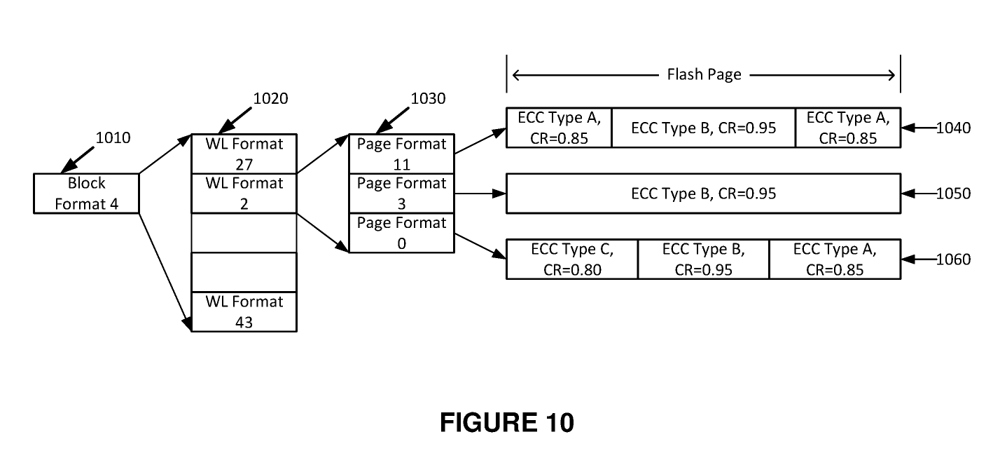

FIG. 10 illustrates an example format hierarchy. FIG. 10 highlights the hierarchical relationship between the block 1010, wordline 1020, and page formats 1030. A block format can reference one or more wordline formats, and a wordline format can reference one or more page formats. The page format describes one or more ECC configurations that specify the ECC code to be used, the code rate, offset within the page, and length.

In this example embodiment, page format 11 1040 includes three different ECC codes across the flash page, while page format 3 1050 has a single ECC code for the flash page, and page format 0 1060 has three different ECC codes across the flash page.

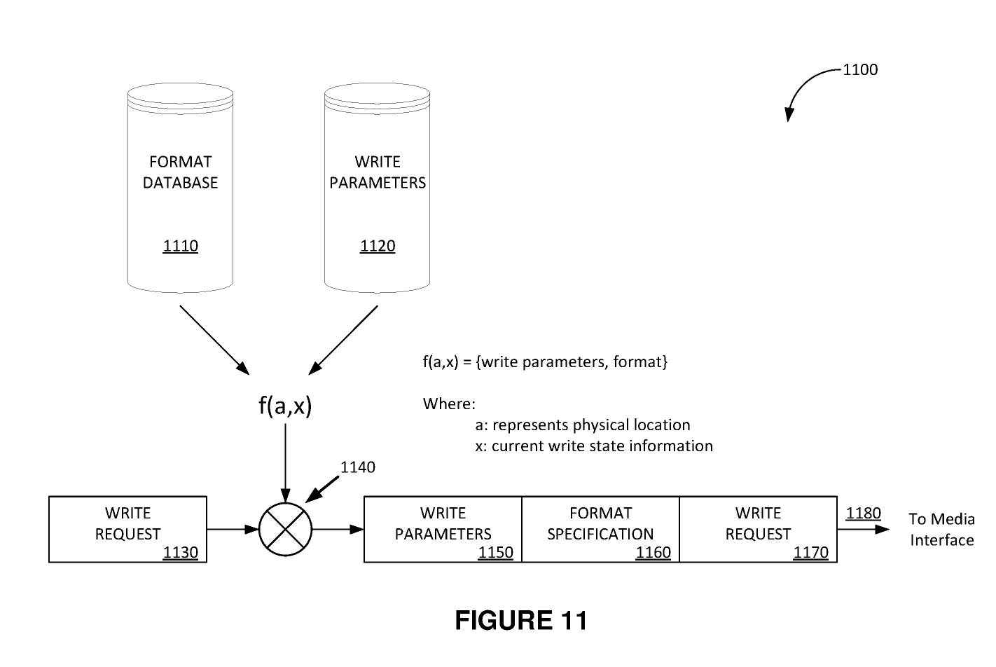

FIG. 11 illustrates an example write flow chart 1100 for determining write parameters and a write format. In this example embodiment, a write request 1130 is received and function f(a, x) 1140 selects write parameters 1150 from write parameters database 1120, and format specification 1160 from format database 1110. Write request 1170 is then sent 1180 to the media interface.

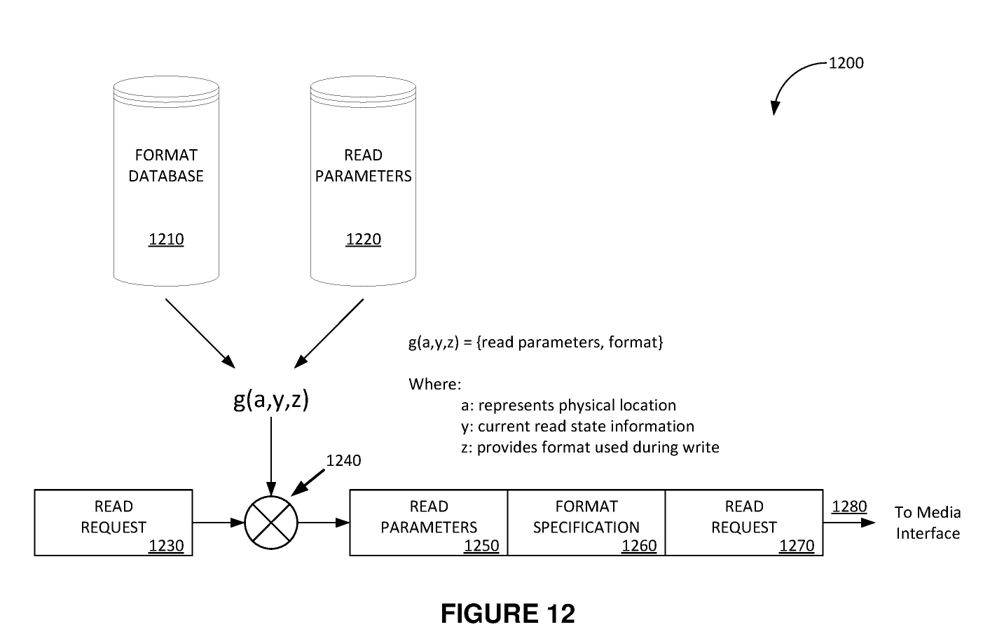

FIG. 12 illustrates an example read flow chart 1200 for determining read parameters and a read format. In this example embodiment, a read request 1230 is received and function g(a, y, z) 1240 selects read parameters 1250 from read parameters database 1220, and format specification 1260 from format database 1210. Read request 1270 is then sent 1280 to the media interface.

FIGS. 11 and 12 show how the typical write and read flow are augmented to select the appropriate format and set of write/read parameters. The format information is used to properly configure the channel for the upcoming encode/decode of data. The Write/Read parameters are used to generate operations either to the NAND or external hardware in order to alter value/state of the specified parameter(s). This is all done in real-time resulting in the best possible performance and system behavior given the information available.

Examples of x (current write state information) from FIG. 11 include (but are not limited to):
Current temperature vs. some nominal temperature
Current number of program/erase cycles
State information from already programmed neighbors
Density

Examples of y (current read state information) from FIG. 12 include (but are not limited to):
Current temperature vs. some nominal temperature or programming temperature
Current number of program/erase cycles
Current program state of the wordline being read (in case of 2-pass programming has the wordline been fully programmed)
State information from neighbors (programmed or not and to what extent programmed)
Read disturb information
Density
Time from program to current time (relative or absolute)
Time since last read

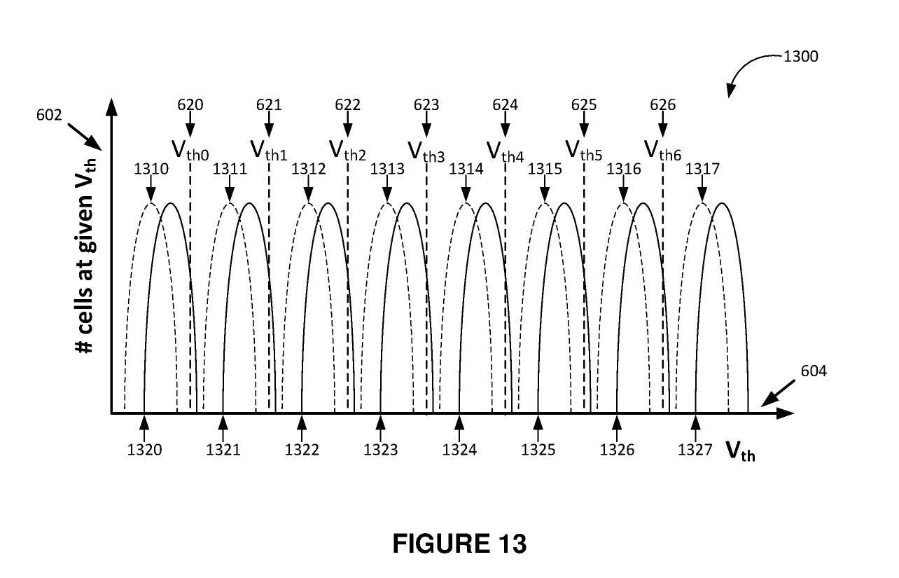

FIG. 13 illustrates an example graph 1300 of stored voltages and voltage thresholds within a flash memory having a bi-modal distribution.

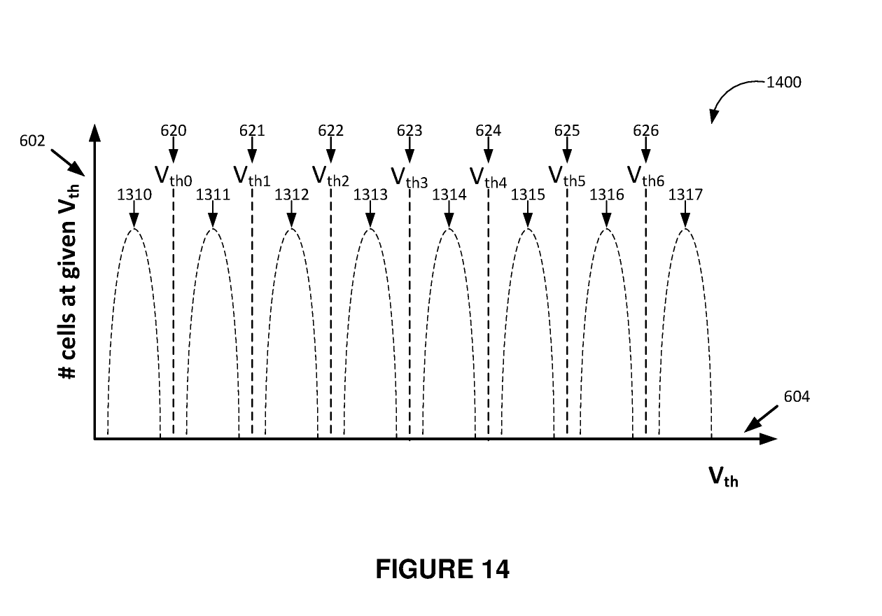

FIG. 14 illustrates an example graph 1400 of stored voltages and voltage thresholds within a flash memory for reading one part of the data illustrated in FIG. 13.

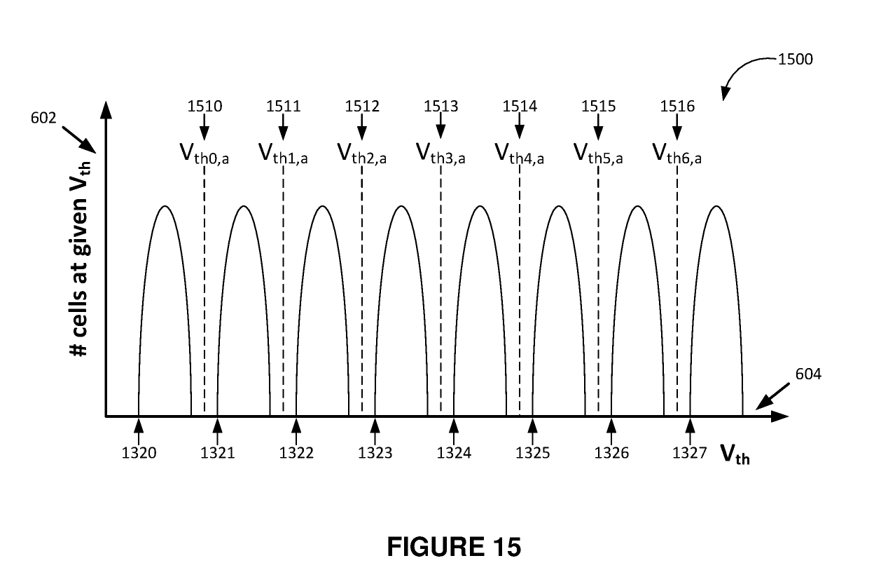

FIG. 15 illustrates an example graph 1500 of stored voltages and voltage thresholds within a flash memory for reading a different part of the data illustrated in FIG. 13.

Together, FIGS. 13, 14, and 15 show a simple scenario where the proposed solution provides benefit to the example system. FIG. 13 illustrates the case where the programmed voltage levels have a bi-modal distribution highlighted by the dashed line 1310-1317 and solid line distributions 1320-1327. Reading the cells with the default read parameters and voltage thresholds Vth0-6 620-626 would result in an increased RBER.

FIGS. 14 and 15 illustrate the situation where 2 sets of read parameters could be applied (one for the dashed line distributions and one for the solid line distributions). In this example, FIG. 14 shows that the dashed line distributions 1310-1317 can be read using the default read parameters and voltage thresholds Vth0-6 620-626. FIG. 15 shows that by adjusting the read parameters and voltage thresholds to Vth0-6, a 1510-1516 the solid line distributions 1320-1327 can be read.

In this case the resulting RBER would be much lower. If the code rate required to support FIG. 13 was 0.85 and the code rate to support FIGS. 14 and 15 was 0.95 a 10% cost/capacity savings could be realized along with all of the potential secondary improvements in terms of read retry trigger rate (governing latency/performance consistency), reduced write amplification, and increased life.

Many existing implementations use a single error correction code and code rate for the entire system along with a default or static set of read parameters for all initial reads. This use model has all of the downsides described above.

Read retries are used in most systems to deal with the situation where the cell voltage distributions are not as expected. This works fine for data integrity, but impacts performance, latency, and potentially endurance (by inducing read disturb that can cause early migration).

Many systems also support a second layer of ECC (most commonly a RAID-like configuration across NAND LUNs) to allow the system to meet its overall UBER requirements when having to compromise on the primary ECC code rate. Again, this works fine for data integrity purposes, but sacrifices performance, latency, and capacity.

There are several alternatives to the system described above, but each has drawbacks when compared to a fully flexible system that can select the optimal ECC to use for each write and read parameters to use for each read. These options, as well as their drawbacks, are described below.

One example option is the manual reset of a channel configuration. However, most systems support at a minimum a few code rates with a fixed type of ECC code, but switching from one configuration to another typically requires halting/flushing the entire system during the switchover. This has obvious and huge impacts to performance a latency.

Another example option is to map out and ignore outlier areas that have naturally higher error rates of different voltage threshold requirements. This works well where there are only a few outlier areas. However, this is typically not the case with NAND flash media, particularly as densities increase, as doing so would severely impact performance and/or endurance.

A further example option is to store unique read thresholds in the NAND device for each page or outlier type. This achieves the same benefit as dynamically specifying read parameters from the controller. However, it comes at the expense of a lot of memory and complexity in the NAND device that increases costs and may not be needed by all users.

Another example option is to use a low-density parity check code (LDPC) with soft data. This option allows for more correction capability to be enabled after the data is originally encoded with a given code rate. However, it suffers from latency and performance issues both in the decoder and in assembling the soft data from the NAND device.

A further example option is to use read retries. Read retries can be utilized in various manners to ensure data integrity, such as use of a second layer ECC, LDPC with soft data, alternate read parameters, and the like. However, even the most elaborate and optimized retry scheme will not equal the performance of an optimally configured system.

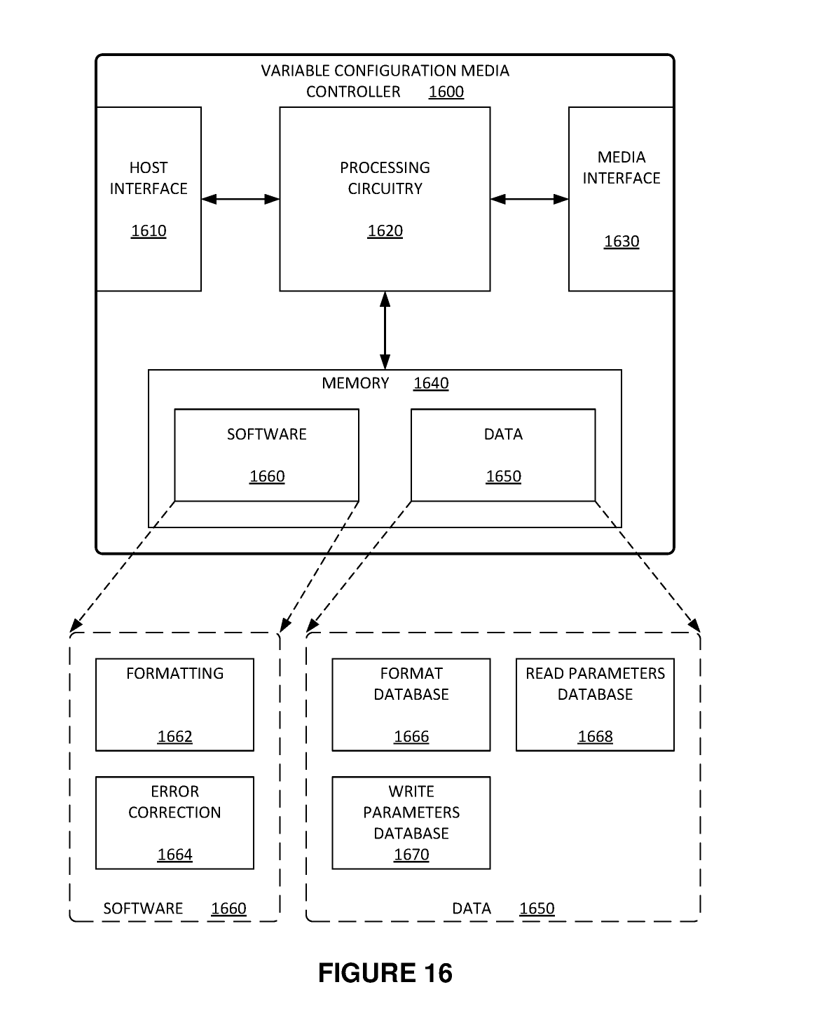

FIG. 16 illustrates variable configuration media controller 1600. As discussed above, variable configuration media controller 1600 may take on any of a wide variety of configurations. Here, an example configuration is provided for a storage controller implemented as an ASIC. However, in other examples, variable configuration media controller 1600 may be built into a storage system or storage array, or into a host system.

In this example embodiment, variable configuration media controller 1600 comprises host interface 1610, processing circuitry 1620, media interface 1630, and memory 1640. Host interface 1610 comprises circuitry configured to receive data and commands from external host systems and to send data to the host systems. Media interface 1630 comprises circuitry configured to send data and commands to storage media and to receive data from the storage media.

Processing circuitry 1620 comprises electronic circuitry configured to perform the tasks of a storage controller as described above. Processing circuitry 1620 may comprise microprocessors and other circuitry that retrieves and executes software 1660. Processing circuitry 1620 may be embedded in a storage system in some embodiments. Examples of processing circuitry 1620 include general purpose central processing units, application specific processors, and logic devices, as well as any other type of processing device, combinations, or variations thereof. Processing circuitry 1620 can be implemented within a single processing device but can also be distributed across multiple processing devices or sub-systems that cooperate in executing program instructions.

Memory 1640 can comprise any non-transitory computer readable storage media capable of storing software 1660 that is executable by processing circuitry 1620. Memory 1640 can also include various data structures 1650 which comprise one or more databases, tables, lists, or other data structures. Memory 1640 can include volatile and nonvolatile, removable and non-removable media implemented in any method or technology for storage of information, such as computer readable instructions, data structures, program modules, or other data.

Memory 1640 can be implemented as a single storage device but can also be implemented across multiple storage devices or sub-systems co-located or distributed relative to each other. Memory 1640 can comprise additional elements, such as a controller, capable of communicating with processing circuitry 1620. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof.

Software 1660 can be implemented in program instructions and among other functions can, when executed by variable configuration media controller 1600 in general or processing circuitry 1620 in particular, direct variable configuration media controller 1600, or processing circuitry 1620, to operate as described herein for a variable configuration media controller. Software 1660 can include additional processes, programs, or components, such as operating system software, database software, or application software. Software 1660 can also comprise firmware or some other form of machine-readable processing instructions executable by elements of processing circuitry 1620.

In at least one implementation, the program instructions can include formatting module 1662, and error correction module 1664. Formatting module 1662 includes instructions for data formatting in reading and writing data to storage media as described above. Error correction module 1664 includes instruction for encoding data using an ECC and for detecting and correcting data errors when reading data from the storage media.

In at least one implementation, the data structures can include format database 1666, read parameters database 1668, and write parameters database 1670, such as those illustrated in FIG. 9.

In general, software 1660 can, when loaded into processing circuitry 1620 and executed, transform processing circuitry 1620 overall from a general-purpose computing system into a special-purpose computing system customized to operate as described herein for a storage controller, among other operations. Encoding software 1660 on memory 1640 can transform the physical structure of memory 1640. The specific transformation of the physical structure can depend on various factors in different implementations of this description. Examples of such factors can include, but are not limited to, the technology used to implement the storage media of memory 1640 and whether the computer-storage media are characterized as primary or secondary storage.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above may be combined in various ways to form multiple embodiments. As a result, the invention is not limited to the specific embodiments described above, but only by the claims and their equivalents.

What is claimed is:

1. A storage controller for a storage system, comprising:
a host interface, configured to receive data from, and transmit data to, a host system;
a media interface, configured to transmit data to, and receive data from, storage media; and
a processing system coupled with the host interface and the drive interface, configured to:
receive data from the host system via the host interface;
select write locations within the storage media for writing the data;
select a write format based at least in part on the write locations within the storage media;
select write parameters based at least in part on the write locations within the storage media and media states of the write locations within the storage media; and
write the data to the write locations within the storage media using the selected write format and write parameters via the media interface.

2. The storage controller of claim 1, wherein the media states include at least one element from the group of: temperature, media wear level, media density, and media states from nearby locations within the storage media.

3. The storage controller of claim 1, further comprising:
a memory coupled with the processing system containing a format database, a read parameters database, and a write parameters database, wherein the format database comprises error correction codes, the read parameters database comprises read voltage thresholds, and the write parameters database comprises write target voltages.

4. The storage controller of claim 3, wherein the processing system is further configured to:
select the write parameters from the write parameters database; and
select the write format from the format database.

5. The storage controller of claim 3, wherein the format database is a hierarchical database comprising block formats, wordline formats, and page formats.

6. The storage controller of claim 1, wherein the processing system is further configured to:
receive a read request from the host system via the host interface;
select read locations within the storage media for reading the data;
select a read format based at least in part on the read locations within the storage media;
select read parameters based at least in part on the read locations within the storage media, the write format used to write the data to the storage media, and the media states of the read locations within the storage media;
read the data from the read locations within the storage media using the selected read format and read parameters via the media interface; and
transmit the data to the host system via the host interface.

7. The storage controller of claim 6, wherein the media states include at least one element from the group of: temperature, media wear level, media density, media states from nearby locations within the storage media, read disturb information, state of wordline being read, time since programming, and time since last read.

8. The storage controller of claim 6, further comprising:
a memory coupled with the processing system containing a format database, a read parameters database, and a write parameters database, wherein the format database includes error correction codes, the read parameters database comprises read voltage thresholds, and the write parameters database comprises write target voltages.

9. The storage controller of claim 8, wherein the processing system is further configured to:
select the read parameters from the read parameters database; and
select the read format from the format database.

10. The storage controller of claim 8, wherein the format database is a hierarchical database comprising block formats, wordline formats, and page formats.

11. A method of operating a storage controller within a storage system comprising:
receiving data from a host system;
selecting write locations within storage media in the storage system for writing the data;
selecting a write format based at least in part on the write locations within the storage media;
selecting write parameters based at least in part on the write locations within the storage media and media states of the write locations within the storage media; and
writing the data to the write locations within the storage media using the selected write format and write parameters.

12. The method of claim 11, wherein the media states include at least one element from the group of: temperature, media wear level, media density, and media states from nearby locations within the storage media.

13. The method of claim 11, wherein the storage controller comprises:
a memory containing a format database, a read parameters database, and a write parameters database, wherein the format database comprises error correction codes, the read parameters database comprises read voltage thresholds, and the write parameters database comprises write target voltages.

14. The method of claim 13, further comprising:
selecting the write parameters from the write parameters database; and
selecting the write format from the format database.

15. The method of claim 13, wherein the format database is a hierarchical database comprising block formats, wordline formats, and page formats.

16. The method of claim 11, further comprising:
receiving a read request from the host system;
select read locations within the storage media for reading the data;
selecting a read format based at least in part on the read locations within the storage media;
selecting read parameters based at least in part on the read locations within the storage media, the write format used to write the data to the storage media, and the media states of the read locations within the storage media;
reading the data from the read locations within the storage media using the selected read format and read parameters via the media interface; and
transmitting the data to the host system.

17. The method of claim 16, wherein the media states include at least one element from the group of: temperature, media wear level, media density, media states from nearby locations within the storage media, read disturb information, state of wordline being read, time since programming, and time since last read.

18. The method of claim 16, wherein the storage controller comprises:
a memory containing a format database, a read parameters database, and a write parameters database, wherein the format database includes error correction codes, the read parameters database comprises read voltage thresholds, and the write parameters database comprises write target voltages.

19. A storage device, comprising:
a data storage medium comprising data storage locations; and
a controller, coupled to the data storage medium and configured to store data onto the data storage medium;
the controller further configured to:
receive data from a host system;
select write locations within the data storage media for writing the data;
select a write format based at least in part on the write locations within the data storage media;
select write parameters based at least in part on the write locations within the data storage media and media states of the write locations within the data storage media; and
write the data to the write locations within the data storage media using the selected write format and write parameters.

20. The storage device of claim 19, wherein the controller is further configured to:
receive a read request from the host system;
select read locations within the data storage media for reading the data;
select a read format based at least in part on the read locations within the data storage media;
select read parameters based at least in part on the read locations within the data storage media, the write format used to write the data to the data storage media, and the media states of the read locations within the data storage media;
read the data from the read locations within the data storage media using the selected read format and read parameters; and
transmit the data to the host system.
